(19) United States
(12) Patent Application Publication
(10) Pub. No.: US 2018/0273829 A1
(43) Pub. Date: Sep. 27, 2018

(54) SAND CONSOLIDATION WITH PETROLEUM PRODUCTS

(71) Applicant: Saudi Arabian Oil Company, Dhahran (SA)

(72) Inventors: Ayman Raja Al-Nakhli, Damman (SA); Ahmad Noor Al-deen Hassan Rizq, Doha (SA)

(21) Appl. No.: 15/937,442

(22) Filed: Mar. 27, 2018

Related U.S. Application Data
(60) Provisional application No. 62/477,051, filed on Mar. 27, 2017.

(51) Int. Cl. C09K 8/565; E21B 36/00; E21B 41/00

(52) U.S. Cl. CPC C09K 8/565; E21B 41/00; E21B 36/008

(57) ABSTRACT

Consolidating sand in a subterranean formation includes decreasing a viscosity of a petroleum product to yield a consolidating material, providing the consolidating material to the subterranean formation, and consolidating sand in the subterranean formation with the consolidating material to yield a consolidated region in the subterranean formation.

### CROSS REFERENCE TO RELATED APPLICATION

This application claims the benefit of U.S. Provisional Application No. 62/477,051, filed Mar. 27, 2017, the entire contents of which is hereby expressly incorporated by reference herein in its entirety.

### TECHNICAL FIELD

This disclosure relates to consolidation of sand in a subterranean formation with petroleum products such as asphaltene and tar.

### BACKGROUND

An estimated 70% of the total oil and gas reserves in the world are located in poorly consolidated reservoirs. Sand production, or sanding, is most common in unconsolidated sandstone formations. Sanding in oil production wells and water injection wells is a pervasive problem. Loose sand decreases injectivity and necessitates costly clean-out operations. Sanding increases production costs, can cause sudden choking of wells, and can create down-hole cavities leading to closure of an entire field. In addition, excessive sand production erodes subsurface equipment as well as surface production facilities.

### SUMMARY

This disclosure describes methods and systems for sand consolidation in a subterranean formation with petroleum products, such as tar and asphaltene.

In a general aspect, consolidating sand in a subterranean formation includes decreasing a viscosity of a petroleum product to yield a consolidating material, providing the consolidating material to the subterranean formation, and consolidating sand in the subterranean formation with the consolidating material to yield a consolidated region in the subterranean formation.

Implementations of the general aspect may include one or more of the following features.

In some embodiments, the petroleum product includes at least one of asphaltene and tar. Decreasing the viscosity of the petroleum product may include combining the petroleum product with a solvent. Suitable solvents include at least one of xylene, benzene, cyclohexane, toluene, methylcyclohexane, isopropyl benzene, decalin, tetralin, methylnaphthalenes. The solvent may include xylene, consist essentially of xylene, or consist of xylene. Some embodiments include combining maltene with at least one of the petroleum product and the solvent before combining the petroleum product with the solvent.

In some embodiments, decreasing the viscosity of the petroleum product includes heating the petroleum product. Heating the petroleum product may include heating the petroleum product with heat released from an exothermic chemical reaction. An example of a suitable exothermic chemical reaction is given by:

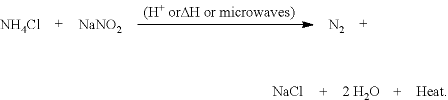

In some embodiments, a viscosity of the consolidating material is in a range of about 1,000 cP to about 10,000 cP at 24° C. In some embodiments, providing the consolidating material to the subterranean formation includes injecting the consolidating material into the subterranean formation. In certain embodiments, consolidating sand in the subterranean formation includes forming chemical or physical bonds between the petroleum product and the sand. Consolidating sand in the subterranean formation may include contacting the sand with the consolidating material and decreasing a viscosity of the consolidating material.

Some embodiments of the general aspect include combining maltene with at least one of the petroleum product and the consolidating material.

In some embodiments, the general aspect includes providing an organic solvent to the subterranean formation to increase a permeability of the consolidated region. Providing the organic solvent to the subterranean formation may include contacting the consolidated region with the organic solvent.

In some embodiments, the consolidating material in the consolidated region includes maltene, and contacting the consolidated region with the organic solvent includes dissolving at least some of the maltene in the consolidated region. The organic solvent typically includes at least one of pentane, cyclohexane, methylcyclohexane, benzene, xylene, toluene, isopropyl benzene, decalin, tetralin, and methylnaphthalenes. The organic solvent may include pentane. In some embodiments, the organic solvent includes n-pentane, consists essentially of n-pentane, or consists of n-pentane. In certain embodiments, maltene is recovered from the consolidated region.

In some embodiments, the general aspect includes identifying a target sand zone in the subterranean formation, and providing the consolidating material to the subterranean formation includes contacting sand in the target sand zone with the consolidating material. In certain embodiments, consolidating sand in the subterranean formation includes consolidating sand in the target sand zone. The target sand zone may include the consolidated region.

The details of one or more implementations of the subject matter described in this specification are set forth in the accompanying drawings and the following description. Other features, aspects, and advantages of the subject matter will become apparent from the description, the drawings, and the claims.

### BRIEF DESCRIPTION OF THE DRAWINGS

FIG. 1 is a flow chart showing an exemplary process for consolidating sand with a petroleum product in a subterranean formation.

FIG. 2 depicts a region of consolidated sand in a subterranean formation.

### DETAILED DESCRIPTION

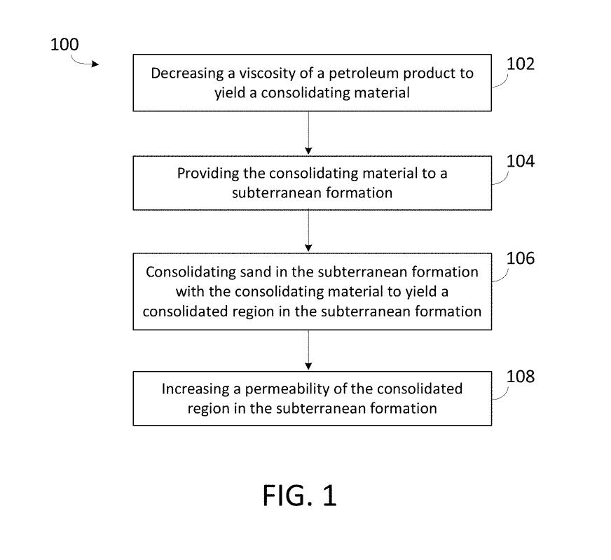

Referring to FIG. 1, process 100 is an exemplary process for consolidating sand with a petroleum product in a subterranean formation. The petroleum product typically has an initial viscosity of at least 1000 cP at 24° C. In some embodiments, the petroleum product includes at least one of asphaltene and tar.

In 102, a viscosity of the petroleum product is decreased to yield a consolidating material. In some embodiments, decreasing the viscosity of the petroleum product includes at least one of heating the petroleum product and combining the petroleum product with an organic solvent. Examples of suitable organic solvents include xylene, benzene, cyclohexane, toluene, methylcyclohexane, isopropyl benzene, decalin, tetralin, and methylnaphthalene. In some embodiments, the solvent includes xylene. In certain embodiments, the solvent consists of or consists essentially of xylene. The volume ratio of solvent to the petroleum product is typically in a range of 5 vol % to 60 vol %. In one example, the volume ratio of the solvent to the petroleum product is about 1:10. A viscosity of the consolidating material is typically in a range of about 1,000 cP to about 10,000 cP at 24° C.

Heating the petroleum product may include using any source of thermal energy to increase a temperature of the petroleum product. The petroleum product may be heated to a temperature in a range of about 90° C. to about 210° C. to decrease its viscosity. In some embodiments, a viscosity of the heated petroleum product is in a range of at least 200 cP.

In one embodiment, heating the petroleum product includes providing heat released from an exothermic chemical reaction to the petroleum product. In certain embodiments, the exothermic chemical reaction includes one or more redox reactants that exothermically react to produce heat and increase pressure in a closed system. Suitable redox reactants include urea, sodium hypochlorite, ammonium containing compounds, and nitrite containing compounds. In some embodiments, the exothermic chemical reaction includes ammonium containing compounds, such as ammonium chloride, ammonium bromide, ammonium nitrate, ammonium sulfate, ammonium carbonate, and ammonium hydroxide. In some embodiments, the exothermic chemical reaction includes nitrite containing compounds, such as sodium nitrite and potassium nitrite. In some embodiments, the exothermic reaction includes at least one ammonium containing compound and at least one nitrite containing compound. One example of a suitable combination of an ammonium containing compound and a nitrite containing compound is ammonium chloride (NH₄Cl) and sodium nitrite (NaNO₂), which react as shown below:

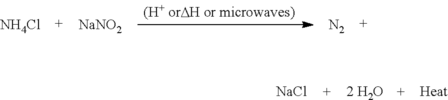

In some embodiments, an additive is combined with at least one of the petroleum product, the organic solvent, and the consolidating material. In some embodiments, the additive includes maltene. In certain embodiments, the additive consists of or consists essentially of maltene.

In 104, the consolidating material is provided to a subterranean formation. In some embodiments, process 100 includes identifying a target sand zone in the subterranean formation, and providing the consolidating material to the subterranean formation includes contacting sand in the target sand zone with the consolidating material. In some embodiments, the consolidating material includes an additive, such as maltene. Providing the consolidating material to the subterranean formation typically includes injecting the consolidating material into the subterranean formation.

In 106, sand in the subterranean formation is consolidated with the consolidating material to yield a consolidated region. Consolidating sand in the subterranean formation typically includes increasing a viscosity of the consolidating material in the subterranean formation. Increasing the viscosity of the consolidating material typically occurs in a range of about 1 to about 24 hours and yields a semi-solid material that binds sand in the subterranation formation. Increasing the viscosity of the consolidating material in the subterranean formation may include removing the organic solvent from the consolidating material, for example, through flooding of the organic solvent using brine, or through lowering of the temperature of the consolidating material in the subterranean formation. That is, the consolidating material may be provided to the subterranean formation at a temperature that exceeds a temperature of the subterranean formation, such the heat from the consolidating material is transferred to the subterranean formation. Consolidating sand in the subterranean formation includes binding the sand with the consolidating material. Binding the sand with the consolidating material typically includes forming chemical or physical bonds between the petroleum product and the sand to form a consolidated sand pack. When a target sand zone is identified before the consolidating material is provided to the subterranean formation, consolidating sand in the subterranean formation includes consolidating sand in the target sand zone. In some embodiments, the target sand zone includes at least part of the consolidated region. In some embodiments, the consolidated region includes at least part of the target sand zone.

In 108, a permeability of the consolidated region is increased. In some embodiments, increasing the permeability of the consolidated region includes providing an organic solvent to the subterranean formation, and contacting the consolidated region with the organic solvent. Providing the organic solvent to the subterranean formation typically includes injecting the organic solvent into the subterranean formation. When the consolidating material in the consolidated region includes maltene, contacting the consolidated region with the organic solvent includes dissolving at least some of the maltene in the consolidated region in the organic solvent. Suitable organic solvents include pentane, cyclohexane, methylcyclohexane, benzene, xylene, toluene, isopropyl benzene, decalin, tetralin, methylnaphthalenes, and mixtures of these compounds. In some embodiments, the organic solvent includes pentane. In certain embodiments, the organic solvent consists of or consists essentially of pentane. In some embodiments, the organic solvent includes n-pentane. In certain embodiments, organic solvent consists of or consists essentially of n-pentane. In certain embodiments, increasing the permeability of the consolidated region includes recovering maltene from the consolidated region.

In some embodiments, operations in process 100 may be combined or omitted. In certain embodiments, an order of operations in process 100 may be changed. In certain embodiments, additional operations may be combined with process 100, such as identifying a target sand zone before decreasing a viscosity of the petroleum product.

Advantages of process 100 include the formation of strong bonds in the consolidated sand pack. Moreover, process 100 is cost effective and is implemented without the use of high-pressure injections that could damage the subterranean formation.

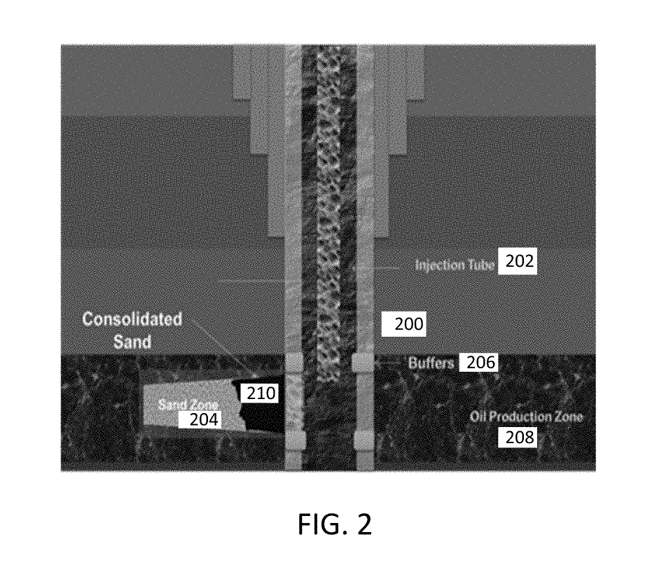

FIG. 2 depicts subterranean formation 200 with injection tube 202 proximate target sand zone 204 between buffers 206 in oil production zone 208. Consolidated region 210 includes sand consolidated with a consolidating material formed by a petroleum product described with respect to FIG. 1.

Thus, particular implementations of the subject matter have been described. Other implementations are within the scope of the claims.

1. A sand consolidation method comprising:
decreasing a viscosity of a petroleum product to yield a consolidating material;
providing the consolidating material to a subterranean formation; and
consolidating sand in the subterranean formation with the consolidating material to yield a consolidated region in the subterranean formation.

2. The method of claim 1, wherein the petroleum product comprises at least one of asphaltene and tar.

3. The method claim 1, wherein decreasing the viscosity of the petroleum product comprises combining the petroleum product with a solvent.

4. The method of claim 3, wherein the solvent comprises at least one of pentane, cyclohexane, methylcyclohexane, benzene, xylene, toluene, isopropyl benzene, decalin, tetralin, and methylnaphthalenes.

5. The method of claim 4, wherein the solvent comprises xylene.

6-7. (canceled)

8. The method of claim 5, further comprising combining maltene with at least one of the petroleum product or the solvent before combining the petroleum product with the solvent.

9. The method of claim 1, wherein decreasing the viscosity of the petroleum product comprises heating the petroleum product.

10. The method of claim 9, wherein heating the petroleum product comprises heating the petroleum product with heat released from an exothermic chemical reaction.

11. The method of claim 10, wherein the exothermic chemical reaction comprises

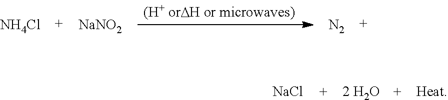

12. The method of claim 1, wherein a viscosity of the consolidating material is in a range of about 1,000 cP to about 10,000 cP at 24° C.

13-14. (canceled)

15. The method of claim 1, wherein consolidating sand in the subterranean formation comprises contacting the sand with the consolidating material and decreasing a viscosity of the consolidating material.

16. The method of claim 1, comprising combining maltene with at least one of the petroleum product and the consolidating material.

17. The method of claim 1, further comprising providing an organic solvent to the subterranean formation to increase permeability of the consolidated region.

18. The method of claim 17, wherein providing the organic solvent to the subterranean formation comprises contacting the consolidated region with the organic solvent.

19. The method of claim 18, wherein the consolidating material in the consolidated region comprises maltene, and contacting the consolidated region with the organic solvent comprises dissolving at least some of the maltene in the consolidated region.

20. The method of claim 19, further comprising recovering maltene from the consolidated region.

21. The method of claim 17, wherein the organic solvent comprises at least one of pentane, cyclohexane, methylcyclohexane, benzene, xylene, toluene, isopropyl benzene, decalin, tetralin, and methylnaphthalenes.

22. The method of claim 21, wherein organic solvent comprises pentane, and the pentane comprises n-pentane.

23-24. (canceled)

25. The method of claim 1, further comprising identifying a target sand zone in the subterranean formation, wherein providing the consolidating material to the subterranean formation comprises contacting sand in the target sand zone with the consolidating material.

26. The method of claim 25, wherein consolidating sand in the subterranean formation comprises consolidating sand in the target sand zone.

27. (canceled)
